(19) United States
(12) Patent Application Publication
(10) Pub. No.: US 2005/0085221 A1
(43) Pub. Date: Apr. 21, 2005

(54) Remotely controlling vehicle functions

(75) Inventor: Anthony J. Sumcad, Southfield, MI (US)

Correspondence Address: General Motors Corporation;Mail Code 482-C23-B21, 300 Renaissance Center, P.O. Box 300, Detroit, MI, 48265-3000, US

(73) Assignee: General Motors Corporation

(21) Appl. No.: 10/690,126

(22) Filed: Oct. 21, 2003

(51) Int. Cl. H04Q 7/00

(52) U.S. Cl. 455/415

(57) ABSTRACT

The current invention provides a system and method for remotely controlling vehicle functions. A call signal is received at a telematics unit from a remote communication device, the call signal including an automatic number identification. A determination is made whether the automatic number identification corresponds to a services authorized number. A services selection message is sent based on the determination. A user response signal to the services selection message is monitored for and a vehicle function command signal is sent based on the user response signal. A computer usable medium with suitable computer program code is employed for remotely controlling vehicle functions.

### FIELD OF THE INVENTION

This invention relates generally to telematics systems. In particular the invention relates to a system and method remotely controlling vehicle functions.

### BACKGROUND OF THE INVENTION

One of the fastest growing areas of communications technology is related to automobile network solutions. The demand and potential for wireless vehicle communication, networking and diagnostic services have recently increased. Although many vehicles on the road today have limited wireless communication functions, such as unlocking a door and setting or disabling a car alarm, new vehicles offer additional Wireless communication systems that help personalize comfort settings, run maintenance and diagnostic functions, place telephone calls, access call-center information, update controller systems, determine vehicle location, assist in tracking vehicle after a theft of the vehicle and provide other vehicle-related services. Drivers can call telematics call centers and receive navigational, concierge, emergency, and location services, as well as other specialized help such as locating the geographical position of a stolen vehicle and honking the horn of a vehicle when the owner cannot locate it in a large parking garage. Telematics service providers can offer enhanced telematics services by supplying a subscriber with a digital handset.

Vehicle lock and unlock services and alerts provided by a telematics call center requires that the call center receive a communication from a subscriber requesting the service. The service center must then verify the subscriber's identity before providing the service to the subscriber. This required intervention increases the cost of supplying telematics services to subscribers. The delay caused by routing the service request through the call center is an inconvenience to the subscriber. These services are often required in time sensitive situations and need to occur with minimal delay.

It is desirable therefore, to provide a system and method for remotely controlling vehicle functions, that overcomes the challenges and obstacles described above.

### SUMMARY OF THE INVENTION

The current invention provides a method for remotely controlling vehicle functions. A call signal is received at a telematics unit from a remote communication device, the call signal including an automatic number identification. A determination is made whether the automatic number identification corresponds to a services authorized number. A services selection message is sent based on the determination. A user response signal to the services selection message is monitored for and a vehicle function command signal is sent based on the user response signal.

Another aspect of the current invention provides a computer usable medium including computer program code for remotely controlling vehicle functions. Computer program code receives a call signal at a telematics unit from a remote communication device, the call signal including an automatic number identification. Computer program code determines whether the automatic number identification corresponds to a services authorized number. Computer program code sends a services selection message based on the determination. Computer program code monitors for a user response signal to the services selection message and sends a vehicle function command based on the user response signal.

Another aspect of the current invention provides a system for remotely controlling vehicle functions. The system comprises means for receiving a call signal at a telematics unit from a remote communication device, the call signal including an automatic number identification; means for determining whether the automatic number identification corresponds to a services authorized number; means for sending a services selection message based on the determination; means for monitoring for a user response signal to the services selection message; and means for sending a vehicle function command based on the user response signal.

The aforementioned and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram of a system for remotely controlling vehicle functions in accordance with one embodiment of the current invention;

FIG. 2 is a flow diagram of a method for remotely controlling vehicle functions in accordance with one embodiment of the current invention;

FIG. 3 is a flow diagram detailing the step of determining whether the automatic identification corresponds to a services authorized number at block 230 of FIG. 2;

FIG. 4 is a flow diagram detailing the step of comparing the automatic number identification of the received call signal to the services authorized numbers in the automatic number identification table at block 330 of FIG. 3; and

FIG. 5 is a flowchart detailing the step of sending a vehicle function command at block 280 of FIG. 2.

### DETAILED DESCRIPTION OF THE PRESENTLY PREFERRED EMBODIMENTS

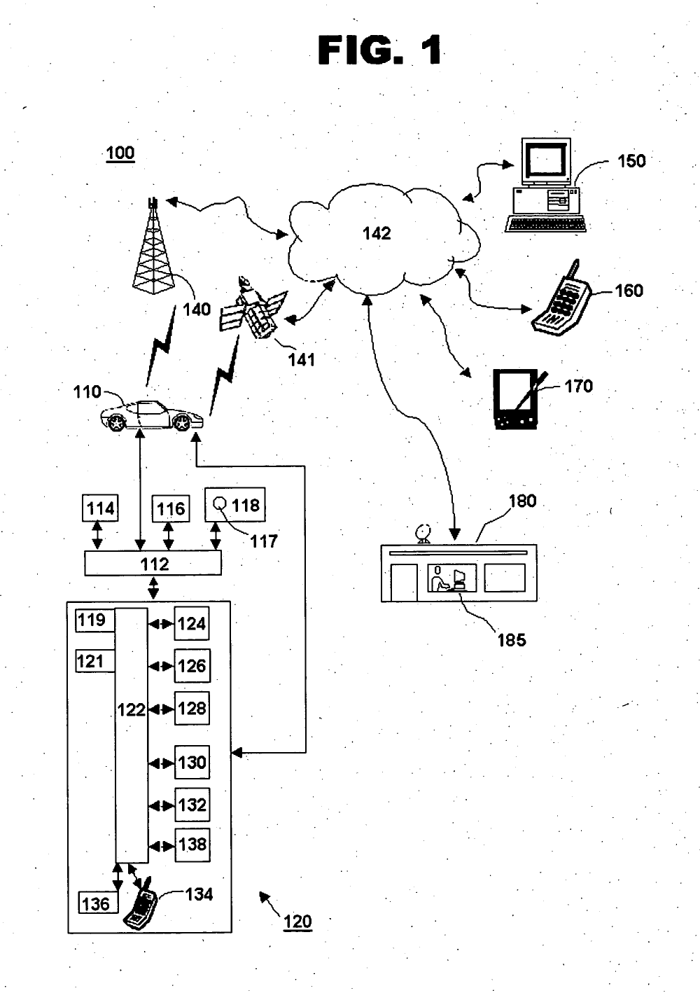

FIG. 1 is a schematic diagram of a system for remotely controlling vehicle functions in accordance with one embodiment of the current invention at 100. System for remotely controlling vehicle functions at 100 comprises: a mobile vehicle 110, a telematics unit 120, one or more wireless carrier systems 140, or one or more satellite carrier systems 141 one or more communication networks 142, and one or more call centers 180. Mobile vehicle 110 is a vehicle such as a car or truck equipped with suitable hardware and software for transmitting and receiving speech and data communications. Vehicle 110 has a multimedia system 118 having one or more speakers 117.

In one embodiment of the invention, telematics unit comprises: a digital signal processor (DSP) 122 connected to a wireless modem 124; a global positioning system (GPS) receiver or GPS unit 126; an in-vehicle memory 128; a microphone 130; one or more speakers 132; an embedded or in-vehicle phone 134 or an email access appliance 136; and a display 138. DSP 122 is also referred to as a microcontroller, controller, host processor, or vehicle communications processor. GPS unit 126 provides longitude and latitude coordinates of the vehicle, as Well as a time stamp and a date stamp. In-vehicle phone 134 is an analog, digital, dual-mode, dual-band, multi-mode or multi-band cellular phone.

Telematics unit 120 can store service center GPS location data, vehicle data upload (VDU) records, automatic number identification (ANI) tables and other data files in in-vehicle memory 128. Telematics unit 120 can set or reset calling-state indicators and can enable or disable various cellular-phone functions, telematics-unit functions and vehicle functions when directed by program code running on DSP 122. Telematics unit 120 can send and receive over-the-air messages using, for example, a pseudo-standard air-interface function or other proprietary and non-proprietary communication links.

DSP 122 executes various computer programs and computer program code, within telematics unit 120, that affect programming and operational modes of electronic and mechanical systems. DSP is also referred to as a microcontroller, controller, ASIC, host processor, microprocessor or vehicle communication processor. DSP 122 controls communications between telematics unit 120, wireless carrier system 140 or satellite carrier system 141 and call center 180. A speech-recognition engine 119 (ASR), which can translate human speech input through microphone 130 to digital signals used to control functions of telematics unit, is installed in telematics unit 120. The interface to telematics unit 120 includes one or more buttons (not shown) on telematics unit 120, on multimedia system 118, or on an associated keyboard or keypad that are also used to control functions of telematics unit. A text to speech synthesizer 121 can convert text strings to audible messages that are played through speaker 132 of telematics unit 120 or through speakers 117 of multimedia system 118.

Speech recognition engine 119 and buttons are used to activate and control various functions of telematics unit 120. For example, programming of in-vehicle phone 134 is controlled with verbal commands that are translated by speech-recognition software executed by DSP 122. Alternatively, pushing buttons on interface of telematics unit 120 or on in-vehicle phone 134 is used to program in-vehicle phone 134. In another embodiment, the interface to telematics unit 120 includes other forms of preference and data entry including touch-screens, wired or wireless keypad remotes, or other wirelessly connected devices such as Bluetooth-enabled devices or 802.11-enabled devices.

DSP 122 controls, generates and accepts digital signals transmitted between telematics unit 120 and a vehicle communication bus 112 that is connected to various vehicle components 114, various sensors 116, and multimedia system 118 in mobile vehicle 110. DSP 122 can activate various programming and operation modes, as well as provide for data transfers. In one embodiment of the invention, DSP 122 converts user response signals to vehicle function commands. Vehicle function commands are sent to a control entity that controls a vehicle function via communication bus 112. Vehicle function commands instruct the control entity to execute the vehicle function. Examples of controllable vehicle functions comprise door lock and unlock, flash lights and honk horn. Examples of control entities comprise a powertrain control module (PCM), a body control module (BCM), an electronic control module (ECM), and a theft deterrent control module.

Mobile vehicle 110 via telematics unit 120 sends and receives radio transmissions from wireless carrier system 140, or satellite carrier system 141. Wireless carrier system 140, or satellite carrier system 141 is any suitable system for transmitting a signal from mobile vehicle 110 to communication network 142.

Communication network 142 includes services from mobile telephone switching offices, wireless networks, public-switched telephone networks, and Internet protocol (IP) networks. Communication network 142 comprises a wired network, an optical network, a fiber network, another wireless network, or any combination thereof. Communication network 142 connects to mobile vehicle 110 via wireless carrier system 140, or satellite carrier system 141.

Communication network 142 can send and receive short messages according to established protocols such as dedicated short range communication standard (DSRC), IS-637 standards for short message service (SMS), IS-136 air-interface standards for SMS, and GSM 03.40 and 09.02 standards. In one embodiment of the invention, similar to paging, an SMS communication is posted along with an intended recipient, such as a communication device in mobile vehicle 110.

Call center 180 is a location where many calls are received and serviced at the same time, or where many calls are sent at the same time. In one embodiment of the invention, the call center is a telematics call center, prescribing communications to and from telematics unit 120 in mobile vehicle 110. In another embodiment, the call center 180 is a voice call center, providing verbal communications between a communication service advisor 185, in call center 180 and a subscriber. In another embodiment, call center 180 contains each of these functions.

Communication services advisor 185 is a real advisor or a virtual advisor. A real advisor is a human being in verbal communication with a user or subscriber. A virtual advisor is a synthesized speech interface responding to requests from user or subscriber. In one embodiment, virtual advisor includes one or more recorded messages. In another embodiment, virtual advisor generates speech messages using a call center based text to speech synthesizer (TTS). In another embodiment virtual advisor includes both recorded and TTS generated messages.

Call center 180 provides services to telematics unit 120. Communication services advisor 185 provides one of a number of support services to a subscriber. Call center 180 can transmit and receive data via data signal, such as vehicle data upload (VDU) to telematics unit 120 in mobile vehicle 110 through wireless carrier system 140, satellite carrier systems 141, or communication network 142.

Call center 180 can determine mobile identification numbers (MINS) and telematics unit identifiers associated with a telematics unit access request, compare mobile identification numbers and telematics unit identifiers with a database of identifier records, and send calling-state messages to the telematics unit 120 based on the request and identification numbers.

In one embodiment of the invention call signals are received at telematics unit 120. Call signals are received by telematics unit 120 through embedded phone 134. Call signals are incoming phone calls sent via a service provider selected by the subscriber. Call signals include an automatic number identification that identifies a phone number, a name of the party from whom the call signal originates, or both. A call signal is initiated using a remote communication device, such as a digital handset 160. The digital handset is a portable phone provided by the subscriber's telematics service provider.

Telematics unit 120 has appropriate software enabling it to read the automatic number identification associated with each call signal received. DSP 122 runs program code for comparing the automatic number identification of a call signal to a list of services authorized numbers on an automatic number identification table stored in memory 128. The automatic number identification table comprises a list of phone numbers that are services authorized numbers. Each services authorized number corresponds to a remote communication device from which a subscriber can access the system for remotely controlling vehicle functions. Examples of remote communication devices are a digital handset 160, a handheld device 170 such as a personal digital assistant (PDA), and a user computer 150.

User computer 150 or a handheld device 170 has a wireless modem to send data through wireless carrier system 140, or satellite carrier system 141, which connects to communication network 142. In another embodiment User computer 150 or a handheld device 170 has a wired modem, which connects to communications network 142. Data is received at call center 180. Call Center 180 has any suitable hardware and software capable of providing web services to help transmit messages and data signals from User computer 150 or a handheld device 170 to telematics unit 120 in mobile vehicle 110. User computer 150 or a handheld device 170 can send a user response signal for remotely controlling vehicle functions.

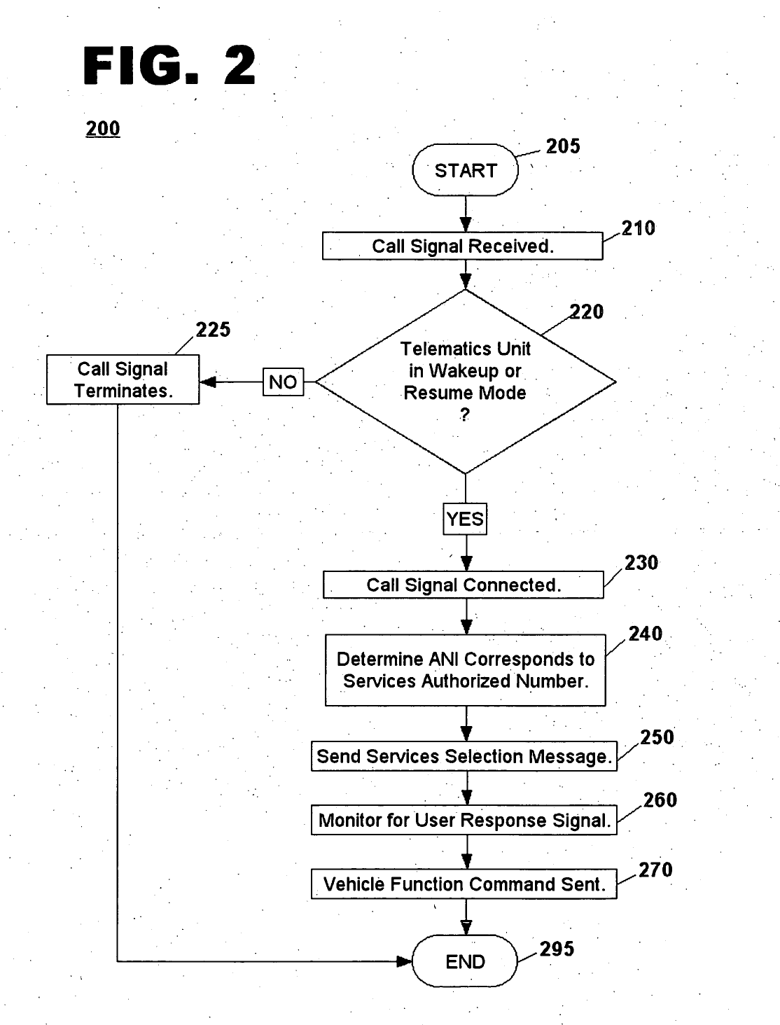

FIG. 2 is a flow diagram of a method for remotely controlling vehicle functions in accordance with one embodiment of the current invention at 200. The method for remotely controlling vehicle functions at 200 begins (block 205) with the telematics unit receiving a call signal with an associated automatic number identification (block 210). The telematics unit is in a wake-up or a resume state to accept call signals and allow remote control of vehicle functions (block 220). If the telematics unit is not in wake-up or resume state, the call signal terminates (block 225) and the method ends (block 295). In another embodiment of the invention, the call signal is forwarded to the call center when the telematics unit is not in wake-up or resume state.

When the unit is in wake-up or resume state, the call signal is connected (block 230) and it is determined whether the automatic number identification associated with the incoming call signal corresponds to a services authorized number on an automatic number identification table (block 240). For a digital handset solution (DHS) subscriber, the digital handset is assigned a handheld mobile identification number (MIN). The handheld MIN is written as a services authorized number on the ANI table. Other numbers such as a phone number assigned to a non-DHS handset or a subscriber's home or business phone number are written to the ANI table as requested by the subscriber. The telematics unit is assigned a portable MIN. The portable MIN is the phone number a subscriber enters to remotely control vehicle functions.

When the determination is made, a services selection message is sent (block 250). The services selection message is a voice message listing the vehicle functions that can be controlled with a number associated with each of the vehicle functions listed. The services selection message comprises synthesized speech directing the subscriber to select the desired vehicle function for control.

A user response signal in reply to the services selection message is monitored for (block 260). The user response signal is an electronic signal received at the telematics unit. Examples of electronic signals are a touch-tone sent when a handset key is pressed, a data packet sent when a computer key is pressed or a user utterance when a subscriber speaks. In one embodiment of the invention, when the subscriber presses the number corresponding to the desired vehicle function, on the keypad of the digital handset, the user response signal is sent. In another embodiment of the invention, the user utters the number corresponding to the desired vehicle function. The user response signal is the user utterance. In another embodiment of the invention the user utters a phrase comprising the vehicle function for control, such as “unlock door” to select the unlock door function. A vehicle function command is sent based on the user response signal received (block 270) and the method ends (block 295).

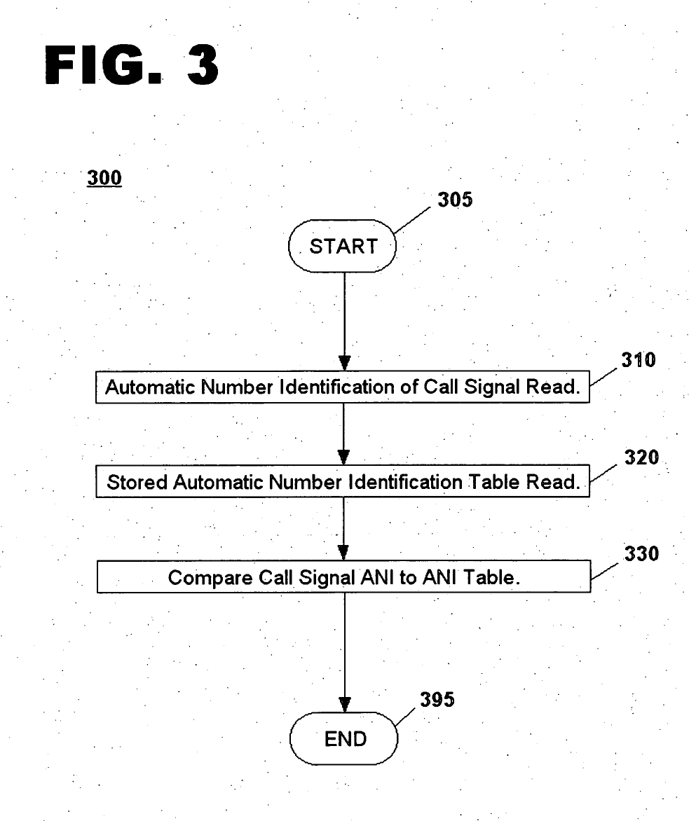

FIG. 3 is a flow diagram detailing the step of determining whether the automatic number identification (ANI) corresponds to a services authorized number at block 230 of FIG. 2 at 300. Determining whether the automatic number identification corresponds to a services authorized number begins (block. 305) when the automatic number identification of the call signal is read (block 310). The stored automatic number identification table, which comprises one or more services authorized numbers, is read (block 320). The automatic number identification of the received call signal is compared to the services authorized numbers on the automatic number identification table (block 330) and the step ends (block 395).

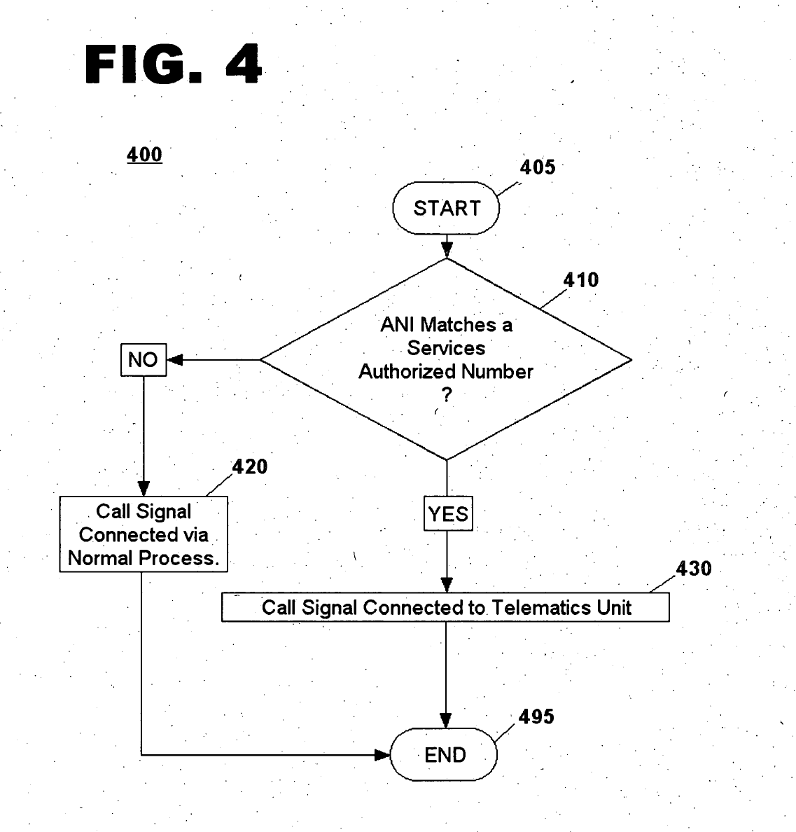

FIG. 4 is a flow diagram detailing the step of comparing the automatic number identification of the received call signal to the services authorized numbers in the automatic number identification table at block 330 of FIG. 3 at 400. The comparison begins (block 405) when a determination is made if the automatic number identification of the received call signal matches at least one services authorized number in the automatic number identification table. The automatic number identification of the received call signal either matches a services authorized number in the automatic number identification table or does not match a services authorized number in the automatic number identification table (block 410).

If the automatic number identification associated with the received call signal does not match at least one services authorized number on the automatic number identification table the call is connected via the normal process (block 420) and the step ends (block 495). The normal process is to treat the call as an incoming personal call and route the call signal to the embedded handset of the telematics unit or to a voicemail system.

If the automatic number identification associated with the received call signal does match at least one services authorized number on the automatic number identification table the call signal is connected to the telematics unit for vehicle function control (block 430) and the step ends (block 495). The telematics unit generates services selection messages and vehicle function command signals as well as monitoring for a user response signal sent in reply to a services selection message.

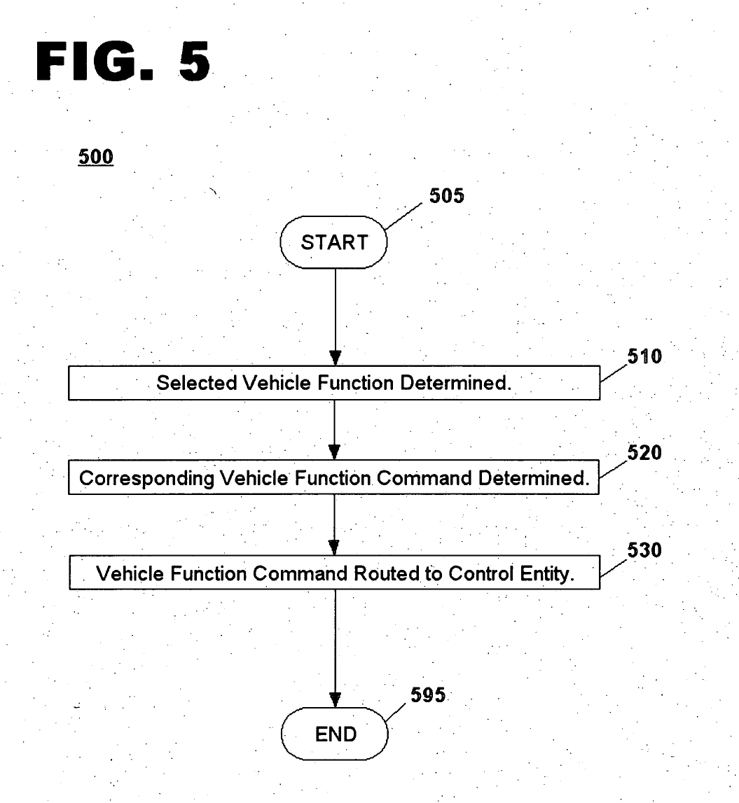

FIG. 5 is a flowchart detailing the step of sending a vehicle function command at block 280 of FIG. 2 at 500. The step of sending a vehicle function command begins (block 505) when a selected vehicle function is determined from a received user response signal (block 510). The vehicle function command corresponding to the selected vehicle function is determined (block 520). The vehicle function command is routed to the control entity for the vehicle function (block 530) and the step ends (block 595).

While embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method for remotely controlling vehicle functions, the method comprising:
receiving a call signal at a telematics unit from a remote communication device, the call signal including an automatic number identification;
determining whether the automatic number identification corresponds to a services authorized number;
sending a services selection message based on the determination;
monitoring for a user response signal to the services selection message; and
sending a vehicle function command signal based on the user response signal.

2. The method of claim 1 wherein determining whether the automatic identification corresponds to a services authorized number comprises:
reading the automatic number identification of the received call signal;
reading an automatic number identification table, the table comprising one or more services authorized numbers; and
comparing the automatic number identification of the received call signal to the service authorized numbers in the automatic number identification table.

3. The method of claim 2 wherein comparing the automatic number identification of the received call signal to the service authorized numbers in the automatic number identification table comprises:
determining if the automatic number identification of the received call signal matches at least one services authorized number in the automatic number identification table; and
connecting the call signal based on the determination.

4. The method of claim 1 wherein sending the services selection message comprises:
sending an electronic message, the electronic message comprising a selection list, the selection list comprising one or more vehicle functions for control.

5. The method of claim 1 wherein monitoring for a user response signal to the services selection message comprises:
receiving an electronic signal corresponding to a selected vehicle function.

6. The method of claim 1 wherein monitoring for a user response signal to the services selection message comprises:
receiving a user utterance corresponding to a selected vehicle function.

7. The method of claim 1 wherein sending a vehicle function command comprises:
determining a selected vehicle function based on a received user response signal;
determining a vehicle function command corresponding to the selected vehicle function; and
routing the vehicle function command to a control entity for the selected vehicle function.

8. A computer usable medium including-computer program code for remotely controlling vehicle functions, the computer usable medium comprising:
computer program code for receiving a call signal at a telematics unit from a remote communication device, the call signal including an automatic number identification;
computer program code for determining whether the automatic number identification corresponds to a services authorized number;
computer program code for sending a services selection message based on the determination;
computer program code for monitoring for a user response signal to the services selection message; and
computer program code for sending a vehicle function command signal based on the user response signal.

9. The computer usable medium of claim 8 wherein the computer program code for determining whether the automatic identification corresponds to a services authorized number comprises:
computer program code for reading the automatic number identification of the received call signal;
computer program code for reading an automatic number identification table, the table comprising one or more services authorized numbers; and
computer program code for comparing the automatic number identification of the received call signal to the service authorized numbers in the automatic number identification table.

10. The computer usable medium of claim 9 wherein the computer program code for comparing the automatic number identification of the received call signal to the service authorized numbers in the automatic number identification table comprises:
computer program code for determining if the automatic number identification of the received call signal matches at least one services authorized number in the automatic number identification table; and
computer program code for connecting the call signal based on the determination.

11. The computer usable medium of claim 8 wherein the computer program code for sending the services selection message comprises:
computer program code for sending an electronic message, the electronic message comprising a selection list, the selection list comprising one or more vehicle functions for control.

12. The computer usable medium of claim 8 wherein the computer program code for monitoring for a user response signal to the services selection message comprises:
computer program code for receiving an electronic signal corresponding to a selected vehicle function.

13. The computer usable medium of claim 8 wherein the computer program code for monitoring for a user response signal to the services selection message comprises:
computer program code for receiving a user utterance corresponding to a selected vehicle function.

14. The computer usable medium of claim 8 wherein the computer program code for sending a vehicle function command comprises:
computer program code for determining a selected vehicle function based on a received user response signal;
computer program code for determining a vehicle function command corresponding to the selected vehicle function; and
computer program code for routing the vehicle function command to a control entity for the selected vehicle function.

15. A system for remotely controlling vehicle functions, the system comprising:
means for receiving a call signal at a telematics unit from a remote communication device, the call signal including an automatic number identification;
means for determining whether the automatic number identification corresponds to a services authorized number;
means for sending a services selection message based on the determination;
means for monitoring for a user response signal to the services selection message; and
means for sending a vehicle function command signal based on the user response signal.

16. The system of claim 15 wherein means for determining whether the automatic identification corresponds to a services authorized number comprises:
means for reading the automatic number identification of the received call signal;
means for reading an automatic number identification table, the table comprising one or more services authorized numbers; and
means for comparing the automatic number identification of the received call signal to the service authorized numbers in the automatic number identification table.

17. The system of claim 16 wherein means for comparing the automatic number identification of the received call signal to the service authorized numbers in the automatic number identification table comprises:
means for determining if the automatic number identification of the received call signal matches at least one services authorized number in the automatic number identification table; and
means for connecting the call signal based on the determination.

18. The system of claim 15 wherein means for monitoring for a user response signal to the services selection message comprises:
means for receiving an electronic signal corresponding to a selected vehicle function.

19. The system of claim 15 wherein means for monitoring for a user response signal to the services selection message comprises:
means for receiving a user utterance corresponding to a selected vehicle function.

20. The system of claim 15 wherein means for sending a vehicle function command comprises:
means for determining a selected vehicle function based on a received user response signal;
means for determining a vehicle function command corresponding to the selected vehicle function; and
means for routing the vehicle function command to a control entity for the selected vehicle function.
